(19) United States
(12) Patent Application Publication
(10) Pub. No.: US 2015/0161756 A1
(43) Pub. Date: Jun. 11, 2015

(54) IMAGE PROCESSING DEVICE, AND NON-TRANSITORY COMPUTER-READABLE STORAGE MEDIUM STORING IMAGE PROCESSING PROGRAM

(71) Applicant: DeNa Co., Ltd., Tokyo (JP)

(72) Inventor: Hironori BONO, Tokyo (JP)

(21) Appl. No.: 14/562,590

(22) Filed: Dec. 5, 2014

(30) Foreign Application Priority Data
Dec. 5, 2013 (JP) 2013-251858

(51) Int. Cl. G06T 1/20; A63F 13/25

(52) U.S. Cl. CPC G06T 1/20; A63F 13/25

(57) ABSTRACT

There are provided a rendering processing unit 20 which generates image data of each frame by performing rendering processing of an image and a display processing unit 22 which actually displays an image of each frame at a predetermined display period on the basis of the image data, where the rendering processing unit 20 starts rendering processing of a next frame after the lapse of time shorter than the display period from a rendering processing start time of a single frame when completing the rendering processing of the single frame of the image data within the time shorter than the display period.

### BACKGROUND OF THE INVENTION

1. Field of the Invention

The present invention relates to an image processing device, which renders an image per frame, and an image processing program.

2. Description of Related Art

There is disclosed a technique which performs rendering processing of an image on a server according to an operation of a client (Japanese Patent No. 5076132). This technique renders a plurality of rendering objects according to a rendering order that is determined by referring to detailed information on each rendering object. At this time, a period where a single frame of image starts to be displayed corresponds with a period where the single frame of image starts to be rendered.

### SUMMARY OF THE INVENTION

### Technical Problems

Now, when the period where the single frame of image starts to be displayed corresponds with the period where the single frame of image starts to be rendered, there is a possibility that the display of an image is delayed or the display of a video is stopped on the client when rendering processing of a certain frame is not completed within a display period of a single frame or when a communication speed between the client and the server is decreased.

An object of the present invention is to provide an image processing device and an image processing program which can prevent the delay or stoppage of the image display.

### Solution

An aspect of the present invention is an image processing device including: a rendering processing unit which generates image data of each frame by performing rendering processing of an image; and a display processing unit which actually displays an image of each frame at a predetermined display period on the basis of the image data, where the rendering processing unit starts rendering processing of a next frame after the lapse of time shorter than the display period from a rendering processing start time of a single frame when completing the rendering processing of the single frame of the image data within the time shorter than the display period.

Another aspect of the present invention is a non-transitory computer-readable storage medium storing an image processing program which causes a computer to function as: a rendering processing unit which generates image data of each frame by performing rendering processing of an image; and a display processing unit which actually displays an image of each frame at a predetermined display period on the basis of the image data, where the rendering processing unit starts rendering processing of a next frame after the lapse of time shorter than the display period from a rendering processing start time of a single frame when completing the rendering processing of the single frame of the image data within the time shorter than the display period.

Here, the rendering processing unit starts the rendering processing of an image of each frame when input time data passes a reference rendering processing start time of each frame determined on the basis of the display period, and preferably starts the rendering processing of the next frame by inputting, as the time data, a time corresponding to a reference rendering processing start time of the next frame after the lapse of time shorter than the display period from the rendering processing start time of the single frame, when completing the rendering processing of the single frame of the image data within the time shorter than the display period.

When the image data already generated by the rendering processing needs to be changed by an input from a user, it is preferred that the rendered image data is discarded and that the rendering processing unit regenerates the image data according to the input from the user.

Moreover, when a difference between the rendering processing start time of a frame of image data and a display start time of the frame goes over a reference time difference, the rendering processing unit preferably delays a rendering start time of a next frame by a predetermined time.

There is further provided a storage unit which caches the image data generated by the rendering processing unit, where the rendering processing unit preferably delays a rendering start time of a next frame by a predetermined time when the number of frames of the image data cached in the storage unit exceeds a predetermined reference number of frames.

### ADVANTAGEOUS EFFECTS OF THE INVENTION

According to the present invention, the image processing device and the image processing program which can prevent the delay or stoppage of the image display can be provided.

### BRIEF DESCRIPTION OF THE DRAWINGS

FIG. 1 is a diagram illustrating a configuration of an image processing device according to an embodiment of the present invention;

FIG. 2 is a diagram illustrating a configuration of a rendering processing unit and a display processing unit according to an embodiment of the present invention;

FIG. 3 is a diagram illustrating a timing of image rendering processing and image display processing performed according to an embodiment of the present invention;

FIG. 4 is a diagram illustrating a delay in the image rendering processing;

FIG. 5 is a diagram illustrating a timing of image rendering processing and image display processing performed according to an embodiment of the present invention;

FIG. 6 is a diagram illustrating rollback performed in the image rendering processing according to an embodiment of the present invention; and

FIG. 7 is a diagram illustrating another example of the image rendering processing according to an embodiment of the present invention.

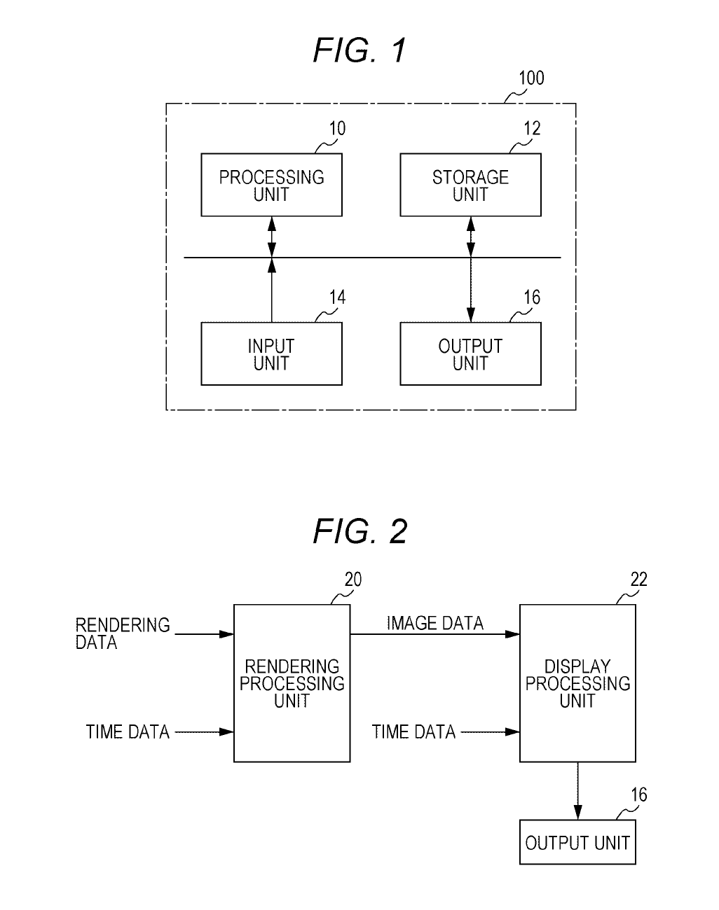

### DETAILED DESCRIPTION OF THE INVENTION

An image processing device 100 according to an embodiment of the present invention includes a processing unit 10, a storage unit 12, an input unit 14, and an output unit 16 as illustrated in FIG. 1. The image processing device 100 includes a basic configuration of a general computer, mobile phone, smart phone, tablet terminal, and the like.

The processing unit 10 includes means such as a CPU which performs arithmetic processing. The processing unit 10 renders and displays an image to be displayed by running an image processing program stored in the storage unit 12. The storage unit 12 includes a storage unit such as a semiconductor memory or a memory card. The storage unit 12 is accessibly connected to the processing unit 10 and stores information such as the image processing program as well as data and a database processed by the image processing device 100. The image processing program of the present embodiment is a program used to perform rendering processing and display processing of an image to be displayed every predetermined period. The input unit 14 includes means to input information to the image processing device 100. The input unit 14 includes for example a touch panel or a button that receives input from a user. The output unit 16 includes a user interface screen (UI) accepting input information from the user and means to output a processed result of the image processing device 100. The output unit 16 includes for example a display presenting an image to the user.

Now, image processing performed in the present embodiment will be described. The image processing is implemented when the image processing device 100 runs the image processing program stored in the storage unit 12. Note that each processing is implemented as means of the image processing device 100.

First, image rendering processing of the image processing device 100 will be described. The image rendering processing processes a set of data specifying the content of an image or a screen (such as a numerical value, a parameter in a mathematical expression, and description of a rendering rule) to obtain a set of pixels used to display a specific image on the output unit 16. That is, the image rendering processing corresponds to a rendering processing unit (renderer) 20 of the image processing device 100.

The rendering processing unit 20 receives rendering data required to generate image data (such as pixel data of a part of a background/character to be included in an image as well as rendering position/angle of each part) and generates (renders) image data to be displayed in the output unit 16 one frame at a time. The rendering data is input from the storage unit 12 of the image processing device 100 or from outside. A typical rendering processing technique may be applied as the rendering processing performed by the rendering processing unit 20. The image data generated (rendered) by the rendering processing unit 20 is temporarily stored in an image buffer area of the storage unit 12.

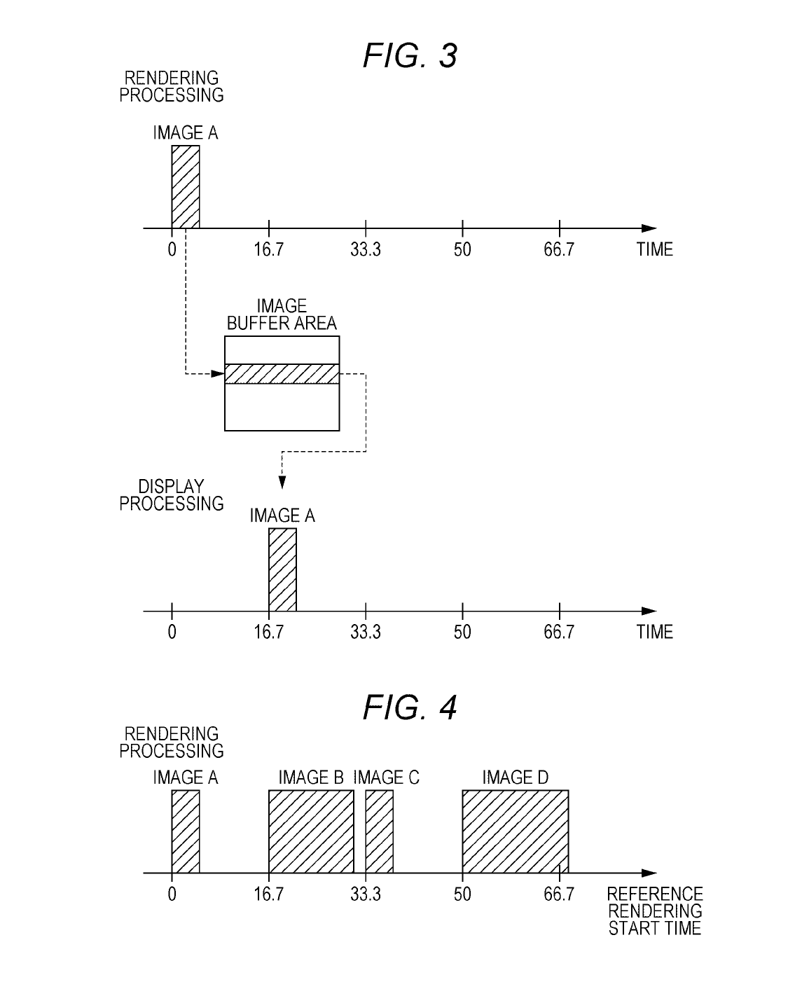

With the reception of input of time data and the time data passing a reference rendering start time, the rendering processing unit 20 uses the input rendering data to start rendering a single frame of image data as illustrated in FIG. 3. Here, the word “passing” includes not only a case where the time data is past the reference rendering start time but also a case where the time data corresponds with the reference rendering start time, namely where the two indicate the same time.

The reference rendering start time is set in synchronization with a display period of rendering display processing to be described later. When 60 frames of images are displayed per second, for example, the display period equals 1/60 s≈16.7 ms. In this case, the rendering processing unit 20 starts rendering the image data at a point when the time data passes 16.7 ms, 33.3 ms, 50 ms, 66.7 ms, and so forth.

When an actual time (such as an actual time output from a clock or the like built-in in the image processing device 100) is input as the time data, for example, the rendering processing unit 20 generates (renders) the image data in synchronization with the display period. In this case, as illustrated in FIG. 4, the image data is generated one frame at a time in order with the period of 1/60 s every time the actual time passes 16.7 ms, 33.3 ms, 50 ms, 66.7 ms, and so forth. This is because it is convenient for image rendering processing performed in an electronic game or the like to accept input of the user and generate a screen reflecting the input.

A display processing unit 22 performs processing of reading, from the image buffer area of the storage unit 12, the image data rendered by the rendering processing unit 20 in the order the image data is stored and displaying an image on the output unit 16 on the basis of the image data being read.

With the reception of input of the time data and the time data passing a reference display start time, the display processing unit 22 starts display processing of a single frame of image based on the rendering data being read, as illustrated in FIG. 3.

The reference display start time is set in synchronization with the display period. When 60 frames of images are displayed per second, for example, the display period equals 1/60 s≈16.7 ms. In this case, the display processing unit 22 starts displaying the image at a point when the time data passes 16.7 ms, 33.3 ms, 50 ms, 66.7 ms, and so forth.

When the actual time (such as the actual time output from the clock or the like built-in in the image processing device 100) is input as the time data, for example, the display processing unit 22 displays the image data in synchronization with the display period. In this case, the image data stored in the image buffer area of the storage unit 12 is read one frame at a time in order with the period of 1/60 s every time the actual time passes 16.7 ms, 33.3 ms, 50 ms, 66.7 ms, and so forth so that the display is performed on the basis of the image data.

Where the actual time is input as the time data to the rendering processing unit 20, the image data may not be rendered in time for the display processing of an image to be performed at a next reference display start time when the rendering processing of the image data takes longer than the display period, as illustrated in FIG. 4. In the example illustrated in FIG. 4 where the rendering processing of an image D is started at the reference rendering start time of 50 ms, the rendering processing of the image D takes longer than the display period, going over the next reference rendering start time of 66.7 ms.

When the rendering processing of the image data is completed in a time shorter than the display period, in the present embodiment, the rendering processing of a next frame is started after the lapse of time shorter than the display period from the rendering processing start time of the frame. Here, when the rendering processing of a single frame of image data is completed in the time shorter than the display period, the time data corresponding to the reference rendering processing start time of the next frame is input to the rendering processing unit 20 after the lapse of the time shorter than the display period from the rendering processing start time of the single frame. The rendering processing unit 20 thus receives, as the time data, the apparent time corresponding to the reference rendering processing start time of the next frame different from the actual time and starts the rendering processing of the next frame.

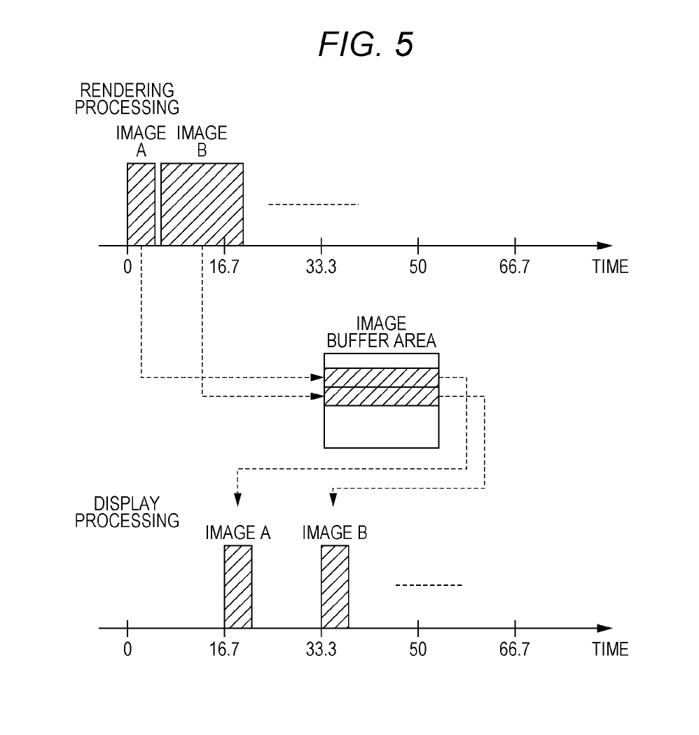

When the rendering processing of a first frame is started at time 0 and completed within the display period (1/60 s=16.7 ms) from time 0 as illustrated in FIG. 5, for example, the apparent time (16.7 ms) corresponding to the reference rendering processing start time of a next frame is input as the time data to the rendering processing unit 20 before the actual time is 16.7 ms. The input apparent time data being the reference rendering processing start time, the rendering processing unit 20 immediately starts the rendering processing of the next frame of image data. The rendered image data is then temporarily stored in the image buffer area of the storage unit 12.

As a result, there is time to spare for the rendering processing of the image data against the display processing by performing the rendering processing of the image data in the time interval shorter than the display period, whereby the delay of the image display or skipping of a frame can be prevented.

Moreover, when testing the image display of an electronic game or the like in a short time in the development of the electronic game, the rendering processing and the display processing may be performed faster than when the game is actually played.

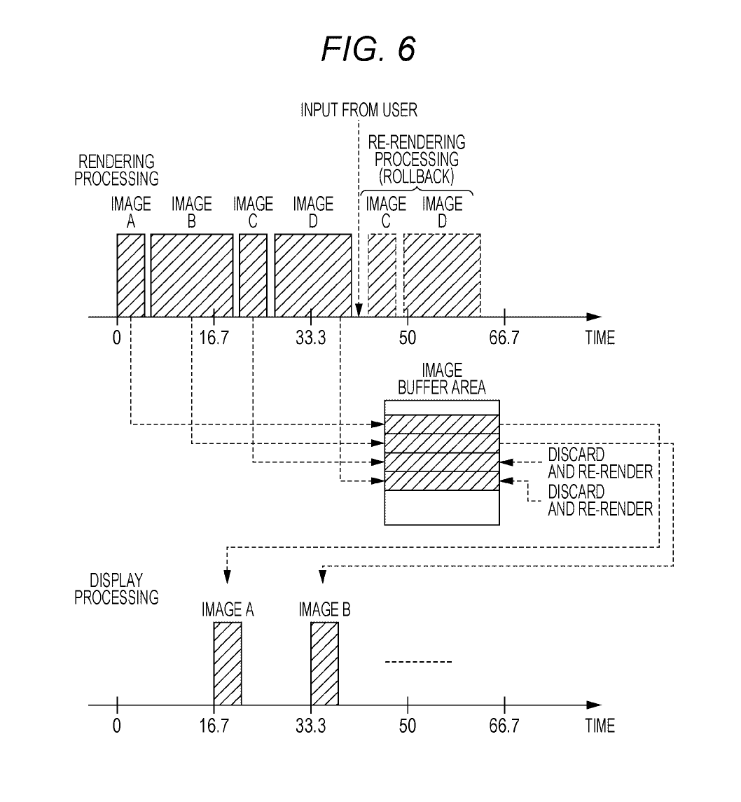

Note that the image display may be changed according to an input from the user in the image rendering processing of the electronic game or the like, where it is sometimes required to make a change to the image data already generated by the rendering processing and cached, in accordance with the input from the user. When there is accumulated image data that is rendered ahead of time but not yet displayed in the image buffer area of the storage unit 12 as illustrated in FIG. 6, for example, there is sometimes a need to make a change to the accumulated image data by the input or the like from the user. In this case, it is preferred that the rendered image data is discarded from the image buffer area of the storage unit 12 and at the same time the rendering processing unit 20 regenerates the image data according to the input from the user. The rendering processing unit 20 at this time inputs rendering data changed according to the input from the user and inputs a reference rendering processing start time of a next frame as the time data. As a result, the rendering processing of the image data reflecting the input from the user is performed.

Moreover, a start time of the rendering processing may be controlled according to a transaction. The more image data cached in the image buffer area of the storage unit 12, possibly the more image data that needs rollback when the input is made from the user before the data is displayed. Accordingly, when a difference between the rendering processing start time of a frame of image data and the display start time of the frame goes over a reference time difference, the rendering processing unit 20 may delay the rendering start time of a next frame by a predetermined time.

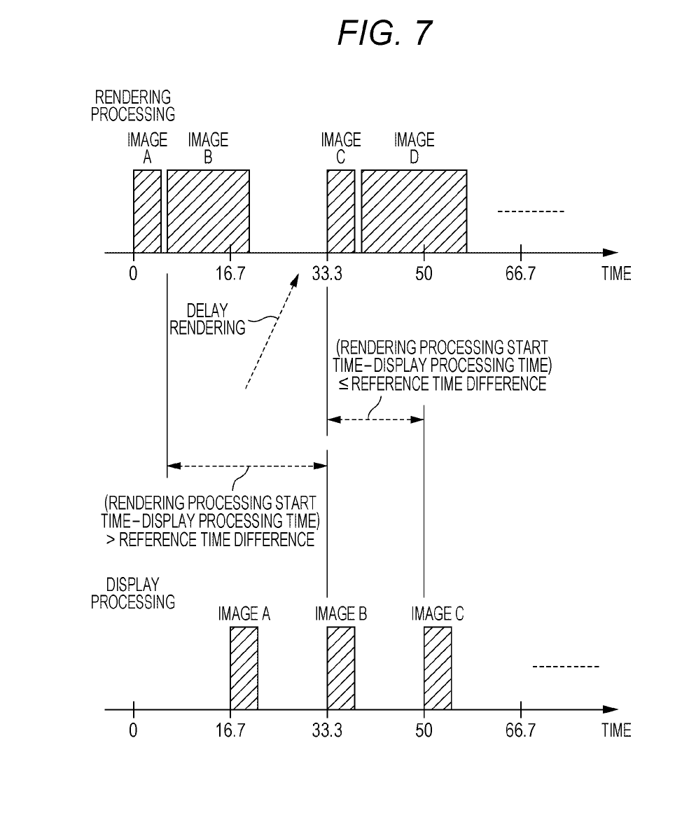

The reference time difference is preferably set to the same time as the display period, for example. In this case, as illustrated in FIG. 7, the rendering start time of the next frame is delayed by the predetermined time when the difference between the rendering processing start time of the frame of image data and the display start time of the frame goes over the display period. FIG. 7 illustrates a case where the rendering processing of an image C is delayed because a difference between the rendering processing start time and the display start time of an image B goes over the display period (16.7 ms) after performing the rendering processing on the image B. At this time, for example, the rendering start time of the next image data (next frame) is delayed until the next reference rendering processing start time (33.3 ms).

Moreover, the rendering processing unit 20 may delay the rendering start time of the next frame by a predetermined time when the number of frames of the image data cached in the image buffer area exceeds a predetermined reference number of frames.

The predetermined reference number of frames can be calculated by dividing a memory amount available as the image buffer area by a memory amount required to cache a single frame, for example. In this case, the rendering start time of the next frame is delayed by the predetermined time when the number of frames of the image data cached in the image buffer area exceeds the reference number of frames. Here, the rendering start time of the next frame is delayed until the next reference rendering processing start time, for example.

Note that each processing of the present embodiment may be executed by a single device or may be shared and executed among a plurality of devices. The processing may be shared between the server and the client, for example.

What is claimed is:

1. An image processing device comprising:
a rendering processing unit which generates image data of each frame by performing rendering processing of an image; and
a display processing unit which actually displays an image of each frame at a predetermined display period on the basis of the image data,
wherein the rendering processing unit starts rendering processing of a next frame after the lapse of time shorter than the display period from a rendering processing start time of a single frame when completing the rendering processing of the single frame of the image data within the time shorter than the display period.

2. The image processing device according to claim 1,
wherein the rendering processing unit starts the rendering processing of an image of each frame when input time data passes a reference rendering processing start time of each frame determined on the basis of the display period, and starts the rendering processing of the next frame by inputting, as the time data, a time corresponding to a reference rendering processing start time of the next frame after the lapse of time shorter than the display period from the rendering processing start time of the single frame, when completing the rendering processing of the single frame of the image data within the time shorter than the display period.

3. The image processing device according to claim 1,
wherein, when the image data already generated by the rendering processing needs to be changed by an input from a user, the rendered image data is discarded and at the same time the rendering processing unit regenerates the image data according to the input from the user.

4. The image processing device according to claim 1,
wherein, when a difference between the rendering processing start time of a frame of image data and a display start time of the frame goes over a reference time difference, the rendering processing unit delays a rendering start time of a next frame by a predetermined time.

5. The image processing device according to claim 1, further comprising:
a storage unit which caches the image data generated by the rendering processing unit,
wherein the rendering processing unit delays a rendering start time of a next frame by a predetermined time when the number of frames of the image data cached in the storage unit exceeds a predetermined reference number of frames.

6. A non-transitory computer-readable storage medium storing an image processing program which causes a computer to function as:
a rendering processing unit which generates image data of each frame by performing rendering processing of an image; and
a display processing unit which actually displays an image of each frame at a predetermined display period on the basis of the image data,
wherein the rendering processing unit starts rendering processing of a next frame after the lapse of time shorter than the display period from a rendering processing start time of a single frame when completing the rendering processing of the single frame of the image data within the time shorter than the display period.
